(19) United States
(12) Patent Application Publication
(10) Pub. No.: US 2004/0232257 A1
(43) Pub. Date: Nov. 25, 2004

(54) Spray booth

(76) Inventor: Ralph Venuto SR., Blackwood, NJ (US)

Correspondence Address: BLANK ROME LLP, 600 NEW HAMPSHIRE AVENUE, N.W., WASHINGTON, DC, 20037, US

(21) Appl. No.: 10/784,920

(22) Filed: Feb. 24, 2004

Related U.S. Application Data
(63) Continuation-in-part of application No. 10/721,171, filed on Nov. 26, 2003.
Application No. 10/721,171 is a continuation of application No. 10/272,308, filed on Oct. 17, 2002.
Application No. 10/272,308 is a continuation-in-part of application No. 10/038,856, filed on Jan. 8, 2002, now Pat. No. 6,554,208.
(60) Provisional application No. 60/331,715, filed on Nov. 21, 2001.

(51) Int. Cl. B05B 1/28

(52) U.S. Cl. 239/200; 239/122

(57) ABSTRACT

A spray chamber has a spray system and a ventilation system. The spray system includes a compressor and spray jets that are positioned 360° about a user, from head to toe. A pump sends tanning lotion from a container, through a manifold, where it is distributed to the spray jets via conduits. The tanning lotion is dispensed in the form of a mist having particles sufficiently large in size that they rapidly descend to the floor where they are collected for disposal. The mist clears the booth in approximately 30-90 seconds, without the need for an evacuation system such as a fan or filter.

### RELATED APPLICATION

This application is a continuation-in-part of U.S. application Ser. No. 10/721,171, filed Nov. 26, 2003, which is a continuation of U.S. application Ser. No. 10/272,308, filed Oct. 17, 2002, which is a continuation-in-part of U.S. Pat. No. 6,554,208 B1 filed Jan. 8, 2002, which claims priority to provisional application serial No. 60/331,715, filed Nov. 21, 2001.

### BACKGROUND OF THE INVENTION

Tanning booths have been developed with tanning lamps, so that a user can obtain and maintain a tan all year round, regardless of weather conditions. Tanning booths have proven to be a healthy and effective, and federal guidelines have been established to ensure that tanning booths continue to remain safe. As tanning booths increase in popularity, tanning booth technology continues to improve.

In addition, systems have been developed for coating the human body with chemical compositions. These coating systems are shown, for instance, in U.S. Pat. Nos. 6,305,384, 6,298,862, 6,251,374, 6,199,557, and 5,922,333, all to Laughlin. Common coating compositions include, for instance, self-tanning formulations, suntan lotions, skin toners, skin bleachers, skin lighteners, exfoliants, nutriments, vitamins, massage aides, muscle relaxants, skin treatment agents, burn treatment agents, decontamination agents, cosmetics, wrinkle treatments or removers, moisturizers, preservatives, anti-microbials, thickeners, solvents, emulsifiers, fragrances, stabilizers, sunscreens, surfactants, pH adjusters, anti-caking agents, ingredients to alter the color reaction or oils.

One disadvantage of the prior systems, however, is that they require moving parts, which subject the user to injury if the user comes in contact with those parts. Another disadvantage of the prior coating systems is that they require the user to rotate in order to achieve a complete coating of composition. That movement subjects the user to injury if the user comes in contact with the projections of the spray system, or if the user loses his/her balance.

Movement is especially dangerous due to the presence of chemicals in the air and since the user will often close his/her eyes during application of the composition. In addition, by requiring that the user rotate to achieve a complete application of composition, the prior coating systems are slow and require multiple spray applications (e.g., a front and back application). Yet another disadvantage is that prior systems permit mist to escape from the spray chamber into to the surrounding area (typically a salon).

Another disadvantage of prior systems is that it is difficult to exhaust the mist from the booth after the spray is complete. The use of a filter impedes the air flow, which can tend to slow down the rate at which mist can be removed from the spray booth.

### SUMMARY OF THE INVENTION

Accordingly, it is a primary object of the invention to provide a spray booth for coating a user with a composition and is able to quickly exhaust remnant mist once the spray is complete. It is another object of the invention to provide a booth that has a single chamber which coats the user with a composition. It is another primary object of the invention to provide a spray chamber that does not require moving parts in order to achieve a complete and uniform composition coating. It is another object of the invention to provide a spray chamber that provides a complete and uniform composition coating in a single spray application. It is another object of the invention to provide a spray chamber that includes an exhaust system for removing remnant spray mist out of the spray chamber after the user has been sprayed. It is yet another object of the invention to provide a spray chamber with a spray system that disinfects the chamber after each use. It is a further object of the invention to provide a booth that does not require an exhaust system, and is affordable.

In accordance with these and other objectives, the present invention is a spray chamber having a spray system and a ventilation system. The spray system includes a compressor and stationary spray jets that are positioned 360° about a user, from head to toe. The compressor operates in a spray mode and a drying mode. In the spray mode, the composition is sprayed onto the user through the spray jets in the form of a mist. In the drying mode, air is blown through the jets to dry the user. The spray chamber also includes a shower spray nozzle which, in a rinse mode, emits chlorinated water to clean the spray chamber. The ventilation system includes exhaust fans that operate in the drying mode to draw air and remnant spray mist into a ventilation housing or plenum. The spray is filtered to create droplets that are siphoned by a sump pump as waste to a sewer system.

In another embodiment, the spray chamber uses a pump and a manifold. The pump dispenses composition to the manifold, which distributes the composition to the spray nozzles where it is emitted in the form of a spray. The spray has particles sufficient large in size that it descends and clears from the booth in a relatively short time without the need for an exhaust system.

### BRIEF DESCRIPTION OF THE FIGURES

FIG. 1 is a perspective drawing of the booth in accordance with the preferred embodiment of the invention.

FIG. 2 shows the spray system used with the spray chamber of FIG. 1.

FIG. 3 shows the position of spray jets within the spray chamber of FIG. 1.

FIG. 4 shows the spray chamber in operation.

FIG. 5 is a perspective drawing of the ventilation housing.

FIG. 6 is a top cutaway view of the booth, showing the ventilation housing.

FIG. 7 is a expanded view of the booth.

FIG. 8 is a front view of the fan and motor used in the ventilation housing of FIG. 5.

FIG. 9 is a view of a spray booth in accordance with another preferred embodiment of the invention.

FIG. 10 shows the spray system used with the spray chamber of FIG. 9.

FIG. 11 shows the basin used to collect condensed mist and water.

FIG. 12 shows the booth floor.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

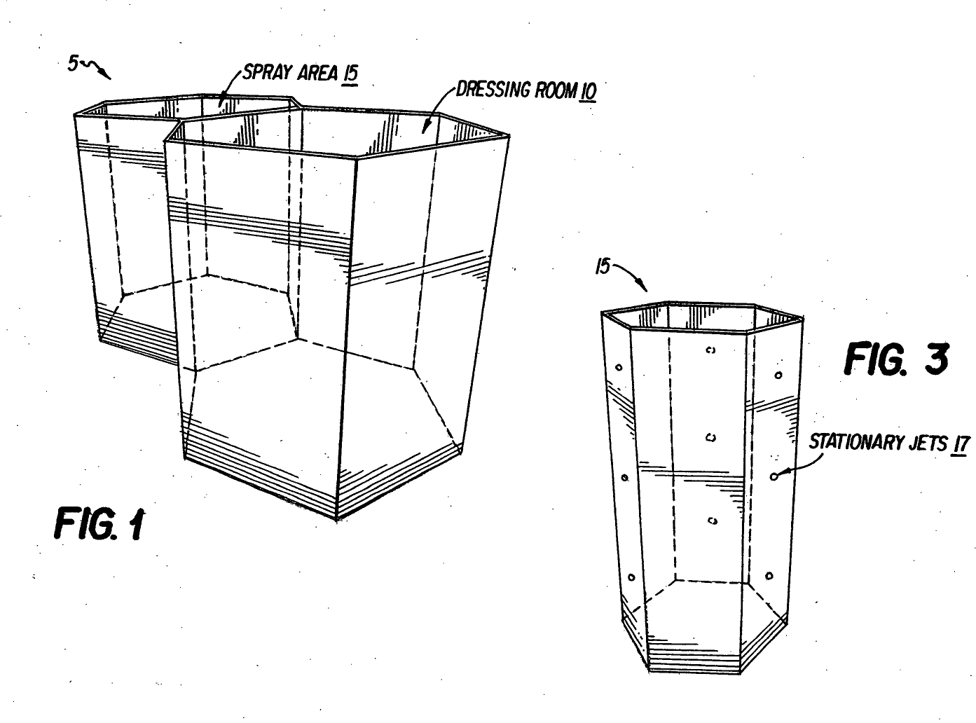

Turning to the drawing, FIG. 1 shows a booth 5 of the present invention having a dressing room 10 and a spray chamber 15. The user generally enters the booth 5 through a door (not shown) in one of the walls of the dressing room 10. The dressing room 10 is generally a changing area that provides privacy for the user to dress after exiting the spray room 15 and to undress before entering the spray chamber 15. An interior door separates the dressing room 10 from the spray chamber 15, and allows the user to pass therebetween. The booth 5 can be constructed in accordance with application Ser. No. 09/836,543, filed Apr. 18, 2001, which is hereby incorporated by reference.

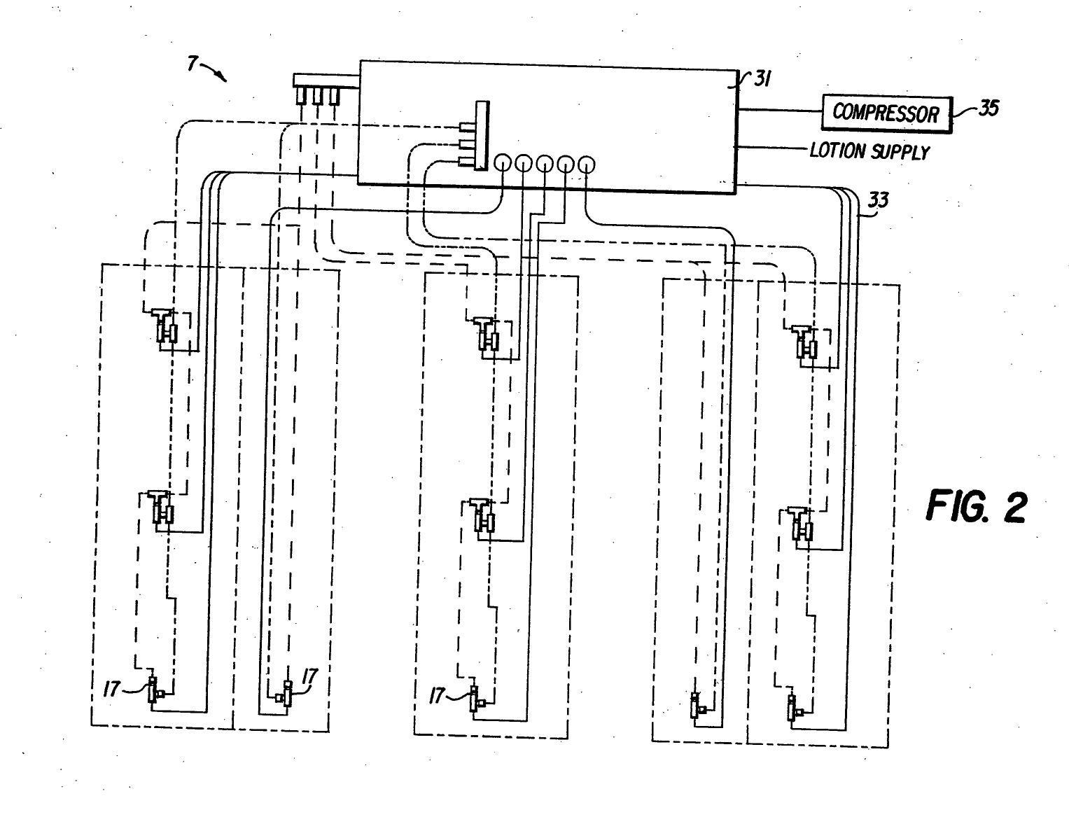

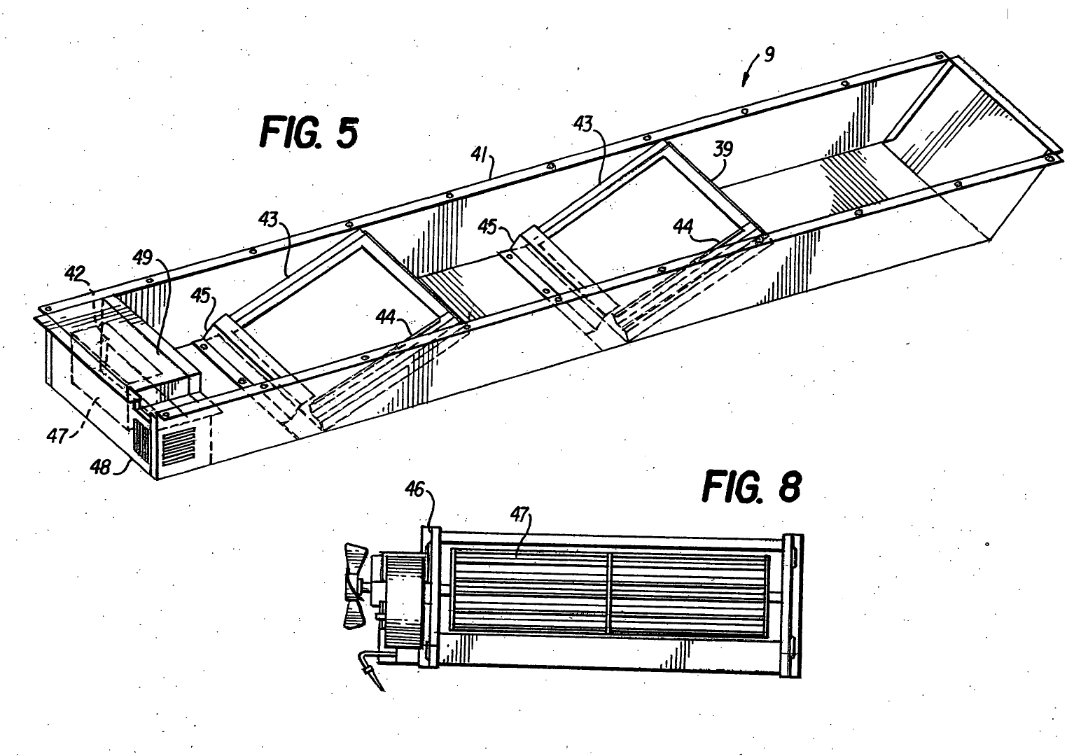

The spray chamber 15 has a spray system 7 (FIG. 2) and a ventilation system 9 (FIG. 5). The spray system 7 provides a complete and uniform application of composition to a user. Though the spray system 7 is preferably implemented with the ventilation system 9, the spray system 7 and the ventilation system 9 are separate systems that can be independently used.

FIGS. 2 and 3 show the preferred arrangement of the stationary spray nozzles or jets 17 located within the spray chamber 15. The spray jets 17 are preferably located in three columns of three jets, plus two extra jets 17 on separate chamber wall panels, for a total of eleven (11) spray jets 17. Each column is positioned vertically on a wall panel of the spray chamber 15. The jets 17 are positioned to provide complete and uniform application of composition to the user in a single treatment, and therefore are located 360° about the user.

The jets 17 also form an upper tier, middle tier and lower tier that cover the user's head and upper body, torso, and lower body, respectively. The two extra jets 17 are provided on the lower tier to provide better coverage of the user's lower body. It should be recognized, however, that any suitable number and positioning of jets 17 can be provided, and the jets 17 need not be vertically or horizontally aligned with each other.

FIG. 2 shows the spray system 7 having spray jets 17, a controller 31, tubing 33, and an air compressor 35. The compressor 35 provides compressed air to the controller 31 via a first tubing 33. The compressor 35 forces the lotion through a second tubing 33 to the nozzles 17, where the first tubing mixes air with the lotion to emit the lotion out through the nozzle 17 in the form of a mist. The compressed air in the first tubing 33 is shown connected to the side of the nozzle connections 17, and the lotion in the second tubing is shown connected to the bottom of the nozzle connections 17. A third tubing also contains compressed air, and is emitted through the nozzles 17 by itself (i.e., without lotion) during a drying mode to dry the user and to clear out the nozzles 17 of any lotion or other blockage. The third tubing 33 is shown connected to the top of the nozzle connections 17.

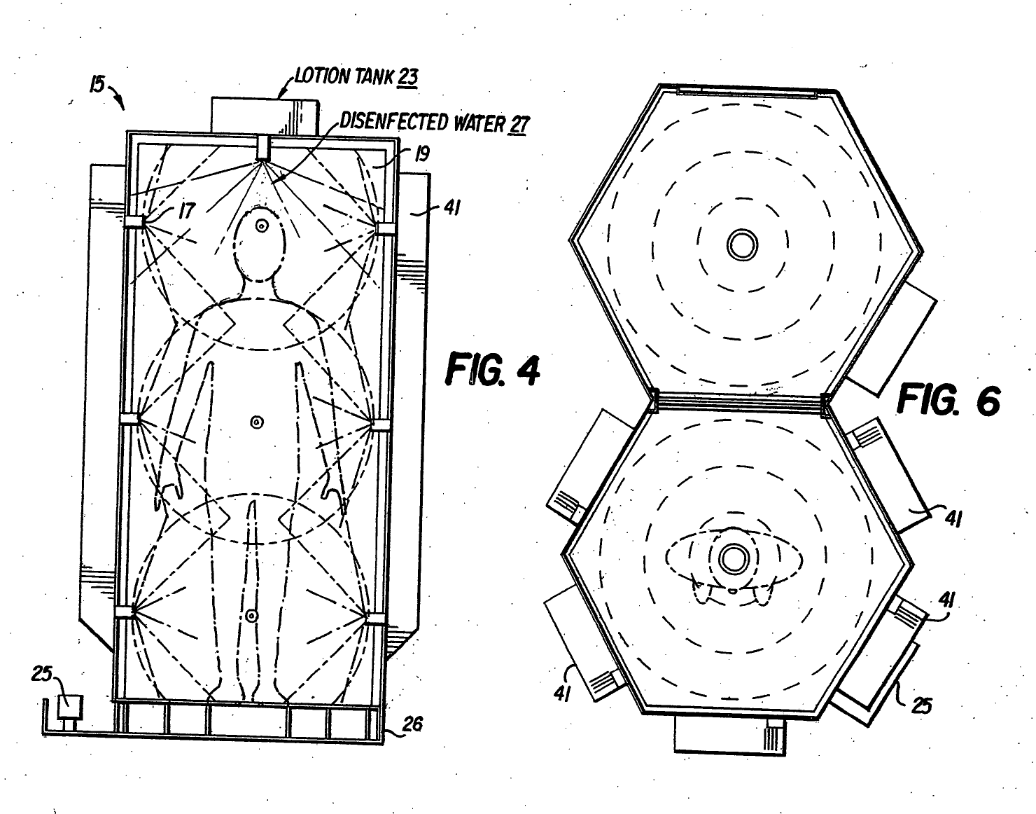

The spray system 7 operates in a spray mode and a drying mode. In the spray mode, the compressor 35 pumps the composition from a tank 23 (FIG. 4) that is preferably located on the top of the spray chamber 15, through the neoprene tubing 33, to the spray jets 17. FIG. 4 shows composition being expelled in the form of a mist or spray 19 from the jets 17 within the spray chamber 15. The jets 17 apply the composition evenly and completely, and do not require the user to rotate or move about the spray chamber 15. The compressor 35 can be adjusted based upon the type of composition being applied as well as the user's height and size. Preferably, however, the compressor imparts a pressure of between approximately 7-11 psi at each jet 17, and the duration of the spray is about 4-10 seconds. Preferably, the composition is applied as a mist in a single application.

The spray system 7 also operates in an optional evacuation or drying mode. The compressor pumps air through the spray jets 17 to dry the user. The drying mode lasts about 40 seconds, though the duration can be adjusted by the user. The drying mode preferably occurs after the spray mode and is followed by the rinse mode.

The spray chamber 15 also has a shower-type nozzle 27 positioned in the ceiling of the spray chamber 15 (FIG. 4). After the drying mode, the spray chamber 15 can optionally enter a rinse mode. In the rinse mode, chlorinated or disinfected water passes through the shower-type nozzle 27 to clean the spray chamber 15.

In accordance with the preferred embodiment of the invention, the spray system 7 enters the spray mode first to apply the composition, which is then followed by the drying mode and the rinse mode. However, the modes can occur in any order, and the spray system 7 can execute multiple cycles—of spray, dry; spray, dry, rinse—for a single user. In addition, the order of the various modes can be varied depending upon various variables, such as user skin type and the tan the user wishes to achieve. For instance, the system can operate as follows: spray, spray, dry, rinse.

As further shown in FIG. 4, the spray chamber 15 also has housings 41. The housings 41 enclose the tubing 33 located on the exterior of the booth 15, and also comprises the ventilation system 9, which is shown in further detail in FIG. 5. The ventilation system 9 includes housings 41, exhaust fans 47, and a sump pump 25. Importantly, the housing 41 forms a plenum that directs the flow of air and spray from the exhaust fans 47 to the bottom of the spray chamber 15.

The housing 41 has two filters 39 that are held at an angled position by a filter holder 43 and a filter stop 44. The fan 47 draws air and spray 19 into the plenum 41 from the interior of the spray chamber, and down along the plenum housing 41. The air and spray 19 pass through filters 39, which condense the spray mist into droplets. The droplets and air are sucked by the sump pump 25 (FIG. 4) as waste to a sewer line. Excess composition and water passes out through openings in the floor of the spray chamber 15, and the sump pump 25 draws the waste to a sewer line.

An air dam 42 is provided with a rectangular opening. The fan 47 blows air through the rectangular opening, and the air dam 42 prevents the backdraft of lotion mist back into the fan and the interior of the spray chamber. A deflector plate 45 is located at the front end of the filter 39 and deflects mist into the filter 39. A fan cover 49 protects the fan 47 and directs the flow of air into the air dam 42. The fan 47 is operated by a motor that is sealed within a motor chamber 48 to prevent mist from damaging the motor.

The fan 47 and motor are shown in greater detail in FIG. 8. The fan 47 has elongated propellers that align to push air through the rectangular opening in the air dam 42. The motor is cooled by a fan that draws in external air through slots in the motor chamber 48 (see FIG. 5). The motor is sealed in the motor chamber 48 by a chamber wall 46, which separates the motor from the fan 47 but allows the motor to operate the fan 47.

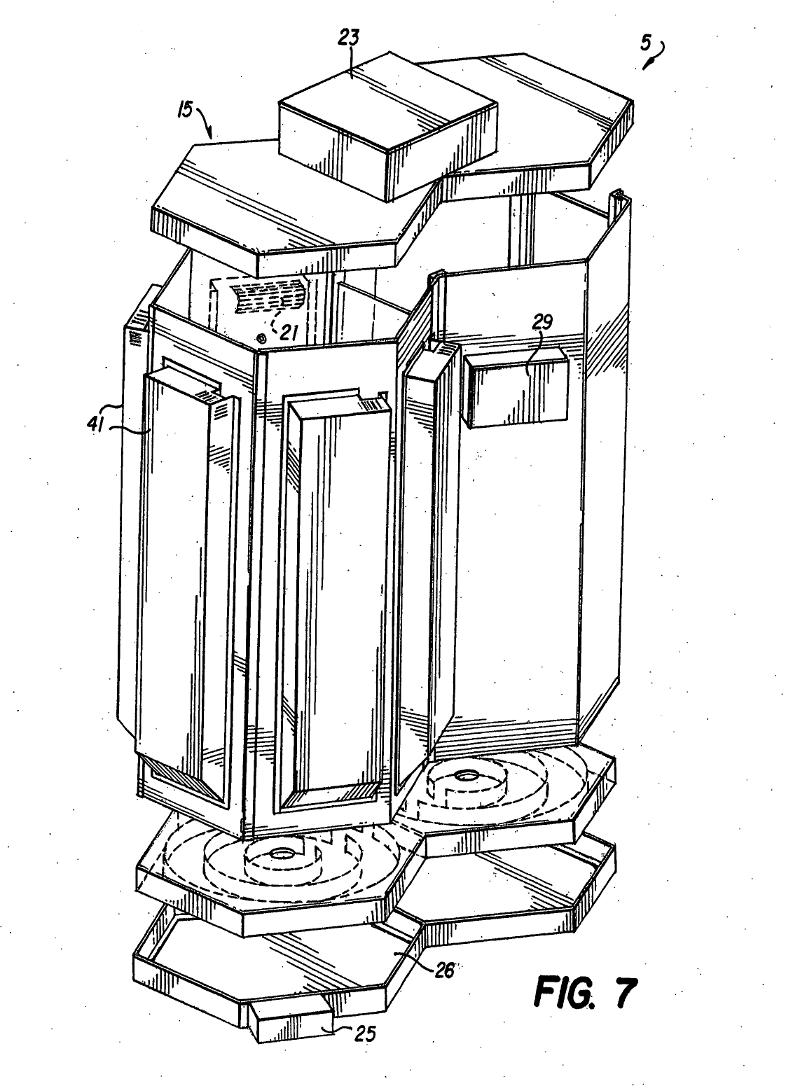

As shown in FIGS. 6 and 7, the plenum housings 41 are positioned along the exterior of the wall panels of the spray chamber 15. The wall panels have vent openings 21 that permit the exhaust fan 47 to draw air and remnant mist into the plenum 41. The spray chamber 15 has a floor that is positioned over a frame with a basin 26 beneath the floor. Excess lotion and water pass through a drain in the floor of the chamber, into the basin 26, where a sump pump 25 passes it to waste. In addition, the mist that is condensed by the plenum 41 passes out of the bottom of the plenum 41 through openings in the wall panels, and into the basin 26. However, the plenum 41 can be alternatively configured so that the condensed mist can pass directly into the basin 26.

The exhaust fans 47 are activated in the drying mode to remove the remnants of the composition spray 19 left over during the spray mode. The exhaust fans 47 are located toward the top of the spray chamber 15, and draw in air and spray 19 to create an upward circulation of spray 19 that further facilitates a complete application of composition to the user. If the air were circulated downward, the user could obtain an incomplete coverage of composition spray 19.

In accordance with the preferred embodiment of FIG. 6, five plenums are provided about the spray chamber 15, one on each exterior wall panel, though any suitable number can be used. The ventilation system is able to exhaust the lotion spray within 30 seconds. The ventilation system and spray chamber 15 are sealed, so that mist does not pass outside the spray chamber 15. A heating and cooling unit can also be provided that allows the user to regulate the temperature of the composition and/or air.

The invention has been described as being implemented in a booth 5 having a dressing room 10 and a spray chamber 15. However, the spray chamber 15 need not be connected with a separate dressing room 10. Thus, the spray chamber 15 can be a room that is dedicated to coating the individual. For example, the spray chamber 15 can be used to apply a medical product for medical treatment of an injury or condition, such as the application of a burn lotion to treat a burn.

The spray chamber 15 is sealed to prevent the escape of water and spray. A control panel 29 is provided that permits the user to control operation of the ventilation system 9 and spray system 7, as well as the rinse and any other devices, such as dressing room lights.

In accordance with a further preferred embodiment of the invention, the filters 39, deflector plate 45, filter holder 43 and filter stop 44 are removed from the plenum 41. Accordingly, remnant mist is sucked into the plenum 41 by the fan 47, and passes straight through and out the bottom of the plenum 41. As the mist passes through the plenum 41, some of the mist condenses on the walls of the plenum 41. The condensed mist exits the plenum 41, and passes through the vent in the booth, through the openings in the floor, and into the basin 26. As noted above, the plenum 41 can be alternatively configured so that the condensed mist can pass directly from the plenum 41 into the basin 26.

By removing the filter 39, obstructions to the flow of air and mist through the plenum 41 is minimized. Thus, the air and mist are able to flow faster through the plenum 41, thereby maximizing the rate at which mist is removed from the booth by the fan 47, and condensed for disposal. In addition, water is kept in the basin 26 to further assist in the condensation of mist in the booth. As mist comes into contact with the water, it condenses, and exits through the drain and passes to waste via sump pump 25. Preferably, approximately one-half inch of water is maintained in the basin 26 for that purpose. Furthermore, the air exiting from the plenum 41 can be directed toward the floor, so that remnant mist flows toward the water in the basin 26. Optionally, a screen can be positioned over the fan 47 so that mist condenses on the screen as it is drawn into the plenum 26. The condensed mist would pass through the plenum 41 into the basin 26.

It should be appreciated that the plenum 41 can be configured in any suitable shape to assist in the condensation of mist, while minimizing any interference with the air flow. For instance, deflector plates 45 can be retained in the plenum 41 to increase condensation of the mist by increasing the number of surfaces contacted by the mist.

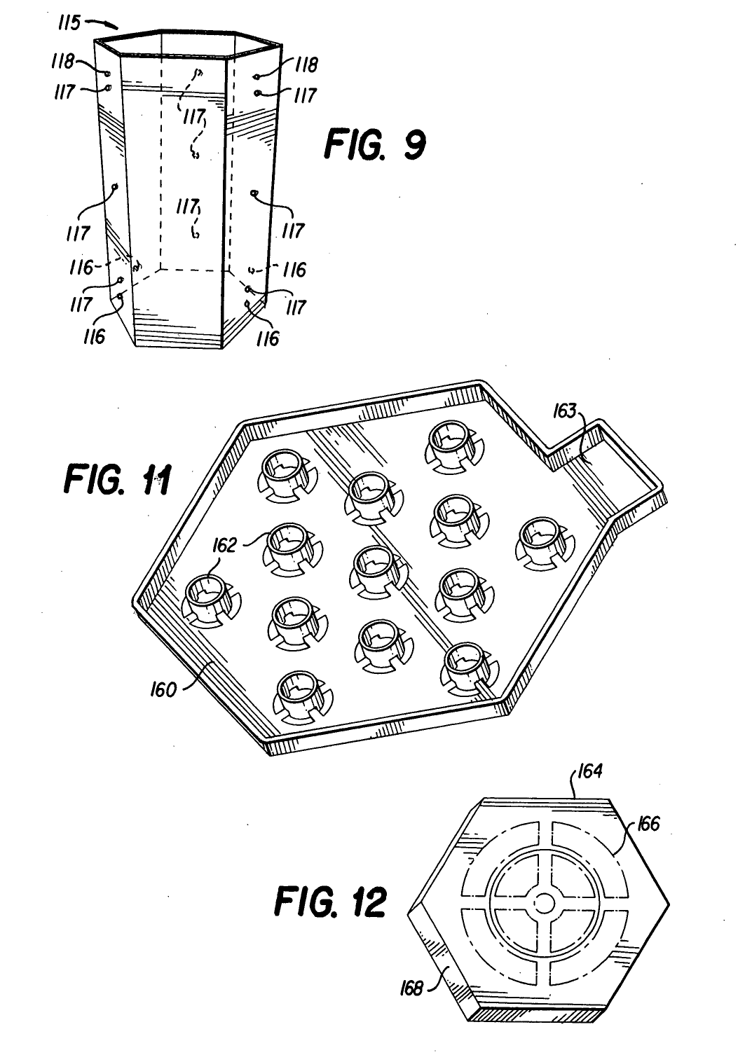

Another embodiment of the invention is shown in FIG. 9. Here, the spray area 115 has nine lotion spray nozzles 117, four diluting or foot washer nozzles 116, and two cleansing or rinsing nozzles 118. The spray nozzles 117 are arranged the same as the spray nozzles 17 of FIGS. 1-8, and spray the tanning lotion onto the user in the form of a mist. The nozzles 117 pass through openings in the booth so that the nozzles 117 are positioned to spray the mist directly into the booth. The nozzles 117, 116, 118, may protrude slightly into the booth so that the booth wall does not interfere with the spray.

The four foot washer nozzles 116 are located toward the bottom of the booth, and are directed at the user's feet and/or calves. Water is emitted from the foot washer nozzles 116 at the same time as the lotion is emitted from the spray nozzles 117. The water dispensed from the foot washer nozzles 116 dilutes the concentration of the tanning lotion that is being sprayed on the user, to reduce the amount of lotion built up at the user's feet and/or calves.

It should be appreciated, however, that the washer nozzles 116 can be positioned to dilute lotion at any part of the user's body and is not limited to the feet and calves. In addition, the foot washer nozzles 116 can emit any liquid, solid, or gas that would serve to dilute the tanning lotion, and need not be water. The foot washing nozzles 116 need not be operated simultaneous with the spray nozzles 117, but can operate for a shorter or longer time than the spray nozzles 117, or before or after the spray nozzles 117.

The rinsing nozzles 118 are preferably located on a wall of the booth and toward the top of the booth 115. The rinsing nozzles 118 are located on either side of the door, and directed to spray water or cleansing liquid onto the walls of the booth to facilitate washing the booth after the user has completed the spray application and has exited the booth. The nozzles 118 have a wide coverage angle, so that each nozzle sprays water onto each wall of the booth, but preferably do not spray water on the ceiling or the front door since very little tanning lotion will contact those surfaces. After the water is sprayed, the walls can be wiped down with a rag or a squeegee. By providing the rinsing nozzles 118 along the wall, instead of the ceiling, any water remaining in the line after the spray stops will not drip onto the user while the booth is in use.

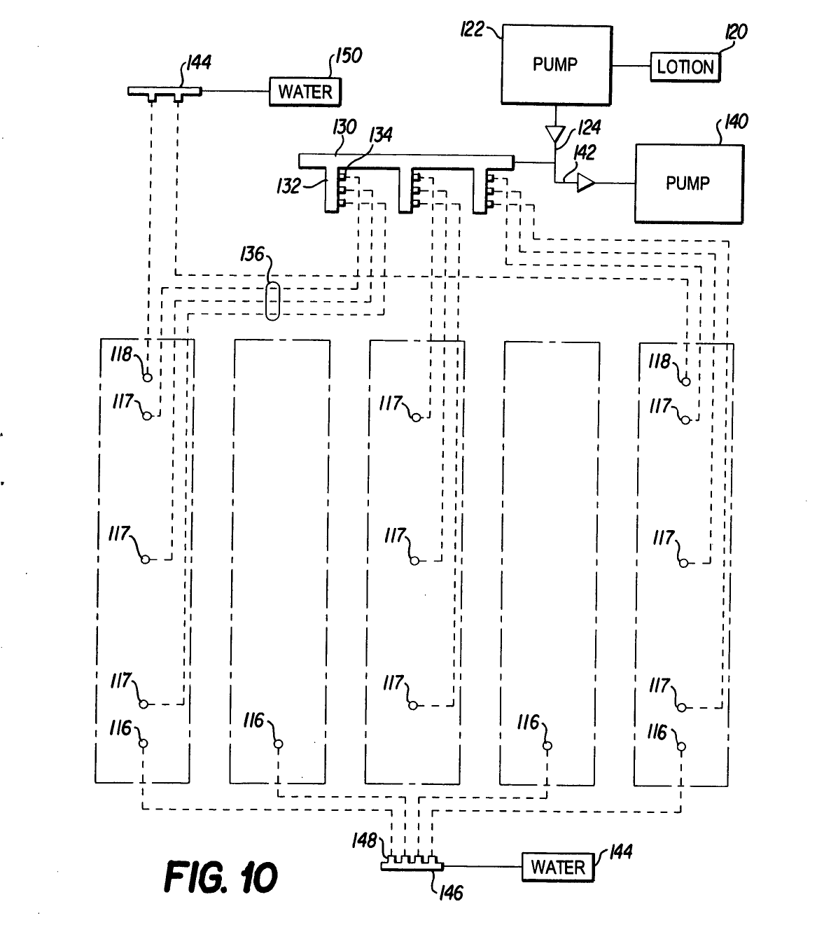

As shown in FIG. 10, the present embodiment includes a container 120 that retains the tanning lotion. An electric motor or pump 122 pumps the lotion to a manifold 130 via a plastic or rubber tubing line 124. The manifold 130 has three arms 132, each arm 132 having three outlet ports 134. A tubing line 136 is connected to each outlet port 134 of the manifold 130, and to the spray nozzles 117 at the wall of the booth. The pump 122 forces the lotion through the manifold 130, out the outlet ports 134, along the tubing lines 136, and out the lotion nozzles 117 with sufficient force to create a mist of the lotion inside the booth. Thus, the manifold 130 controls the distribution of lotion to the various nozzles 117. The manifold 130 splits the lotion to the different outlet ports 134 to deliver the lotion to the nozzles 117.

The pump 122 creates a relatively large size mist particle that descends to the floor of the booth quickly enough that the mist does not linger inside the booth. Once the lotion reaches the floor, it condenses and is collected for disposal. Since the mist does not linger, there is no need for the plenums, fans, or filters of FIGS. 1-8 or exhaust system to remove the mist from the booth. Most of the mist of the present embodiment falls to the floor, and very little condenses on the walls, so that the use of the rinsing nozzles 118 is optional. The mist has particles that are sufficiently large in size so that the composition clears from the booth within a relatively short time period, approximately 30-90 seconds after the pump 122 stops. The size of the lotion particles can be controlled by the pressure of the motor and the size of the nozzle opening.

In contrast, the compressor used in the embodiment of FIGS. 1-8 creates a much finer mist that tends to linger in the air for several minutes, so that the mist has to be removed from the booth by an exhaust system. Motors 122, 140 are also substantially cheaper and more compact than a compressor.

Further to the present embodiment, the lotion need only be sprayed for about 3.5 seconds to completely coat the user. The user remains stationary, though preferably the user's arms and legs are spread slightly so that the tanning lotion can coat inside the user's legs and under the user's arms. The spray nozzles 117 are positioned so that the spray from the nozzles 117 overlaps with each other to coat the user's entire body in a single application.

A second pump 140 may optionally be connected to the manifold 130. The second pump 140 partially withdraws the lotion back out of the lines 136. By doing so, the pump 140 reduces the pressure in the lines 136 so that a uniform spray is achieved for each application and so that the lotion is not emitted from the nozzles 117 at constant pressure and the pressure does not build between uses. The second pump 140 also clears that lotion out of the nozzles 117 so that the lotion does not drip out of the nozzles 117 and along the walls of the booth, and so that the nozzles 117 do not become clogged with lotion.

By having the manifold 130, the distribution of lotion is centralized. Lines 136 can be easily removed and replaced, and the lotion only need be stored at a single reservoir 120. The pump 122 is able to get the lotion to the nozzles 117 quickly. The manifold 130 also enables lotion to be dispensed and withdrawn equally along each of the lines 136, and only a single line need be provided to each nozzle 117. In addition, the lotion can be stored in a single reservoir 120 that can be easily replaced when it is empty. The manifold 130 is preferably located at the rear of the booth close to the pumps, so that it is easy to access.

Preferably, the second pump 140 only partially clears the lines 136, and does not clear the manifold 130. The lotion that is withdrawn can be collected and disposed, such as by draining it to a waste line. A check valve can be provided at line 124 to prevent lotion from being fed back into the first pump 122 when the second pump 140 is operating. Another valve can be provided at line 142 or at the pump 140 that is closed when the first pump 122 is operating to prevent lotion from being pumped through the second pump 140 when the first pump 122 is operating.

As further shown in FIG. 10, a water line is connected to a second manifold 146. The second manifold 146 has four outlet ports 148 that are connected by rubber tubing lines to the foot washing nozzles 116. The water line 144 and manifold 146 can also be connected to the first pump 122 so that the water can be forced through the lines and out of the nozzles 116. As the tanning lotion is emitted by the spray nozzles 117, the water is dispensed through the foot washing nozzles 116. In addition, the water line may also be connected to a manifold 150 to be emitted through rinsing nozzles 118 when the lotion spray is complete.

A digital controller or electronics are provided to control the operation of the pumps 122, 140 and water line 144. In operation, the user presses a button to activate the booth. The first motor 122 automatically turns on and dispenses spray for approximately 3.5 seconds. Once the first motor 122 turns off, the second motor 140 automatically engages to partially withdraw the lotion from the lines 136. Once the user has left the booth, a second button may be pressed to activate the cleansing nozzles 118. Water is forced through the rinsing nozzles 118 for several seconds until any lotion on the walls and floor is washed into the basin 160 (FIG. 11) beneath the floor 164 (FIG. 12).

Turning to FIG. 11, the drainage system for the booth is shown. A basin 160 is provided having floor supports 162. The floor supports 162 are tubes that extend from the bottom of the basin 160 and support the floor 164 (FIG. 12). The floor supports 162 are affixed to the basin 160, such as by adhesive or mechanically fastened.

The floor 164 is made of metal and has downwardly projecting sides 168. The floor 164 fits over the top of the basin 160. The floor 164 has small circular openings arranged in a circular pattern 166. The openings are sufficient small and spaced apart so that the floor 164 can support the user. The openings allow condensed lotion and water to pass through and to be collected in the basin 160. The floor supports 162 have notches cut to allow condensed lotion and water to pass through the supports 162 into the rest of the basin 160. A compartment 163 is provided along one side of the basin 160 and extends out from the booth 115. A small pump (not shown) can be fitted into the side compartment 163 to remove the collected materials from the basin 160 and send it to waste or to a container for collection. The container can be easily removed, emptied and replaced.

The foregoing description and drawings should be considered as illustrative only of the principles of the invention. The invention may be configured is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

I claim:

1. A spray chamber for applying a composition to a user, the spray chamber comprising:
at least one wall;
a reservoir for retaining the composition;
a manifold having an inlet port and outlet ports;
a plurality of spray nozzles positioned at said at least one wall, each of said plurality of spray nozzles in fluid communication with one of the outlet ports of said manifold; and,
a pump in fluid communication with said reservoir and the inlet port of said manifold, whereby said pump dispenses composition from said reservoir through said manifold and out each of said plurality of spray nozzles.

2. The spray chamber of claim 1, further comprising a conduit connected from each of the outlet ports to each of said plurality of spray nozzles for delivering composition from said pump to said spray nozzles.

3. The spray chamber of claim 2, wherein further comprising a suction pump connected to the inlet outlet of said manifold, wherein once said pump ceases forcing the composition through said spray nozzles, said suction pump partially withdraws lotion from each conduit.

4. The spray chamber of claim 1, wherein said pump emits the composition from said spray nozzles in the form of a mist having particles sufficiently large in size that descend substantially quickly.

5. The spray chamber of claim 4, wherein the mist clears from said spray chamber in approximately 30-90 seconds.

6. The spray chamber of claim 4, wherein an exhaust system is not provided to remove mist from said spray chamber.

7. The spray chamber of claim 4, further comprising a floor and a basin beneath said floor, wherein said basin collects the mist that is not deposited on a user.

8. The spray chamber of claim 1, further comprising at least one rinsing nozzle which emits a rinsing agent, said at least one rinsing nozzle rinsing the spray chamber upon completion of the composition being emitted through said spray nozzles.

9. The spray chamber of claim 1, wherein said pump forces the composition through said stationary nozzles to completely coat the user in a single application.

10. The spray chamber of claim 1, wherein said pump forces the composition through said stationary nozzles to completely coat the user as the user remains stationary.

11. The spray chamber of claim 1, wherein said pump forces the composition through said stationary nozzles in the form of a mist.

12. The spray chamber of claim 1, wherein the spray nozzles are stationary.

13. The spray chamber of claim 1, further comprising at least one diluting nozzle positioned at said at least one wall for emitting a diluting agent to dilute the composition being emitted from said spray nozzles.

14. The spray chamber of claim 9, wherein said at least one diluting nozzle is at the bottom of said at least one wall.
